(19) United States
(12) Patent Application Publication
(10) Pub. No.: US 2012/0249869 A1
(43) Pub. Date: Oct. 4, 2012

(54) STATMUX METHOD FOR BROADCASTING

(75) Inventors: Dong Tian, Plainsboro, NJ (US); Hua Yang, Plainsboro, NJ (US); Jill MacDonald Boyce, Manalapan, NJ (US)

(73) Assignee: Thomson Licensing, Issy-les moulineaux (FR)

(21) Appl. No.: 13/515,509

(22) PCT Filed: Dec. 8, 2010
(86) PCT No.: PCT/US10/03116

§ 371 Date: Jun. 13, 2012

Related U.S. Application Data
(60) Provisional application No. 61/284,149, filed on Dec. 14, 2009.

(51) Int. Cl. H04N 7/12

(52) U.S. Cl. 348/388.1; 348/E07.045

(57) ABSTRACT

A statistical multiplexing method is provided that comprises accessing a plurality of video sequences, wherein the video sequences are each assigned to a unique channel in a common broadcast system; collecting information from a plurality of the unique channels assigned to encode the corresponding video sequences; applying rho-domain analysis to the video sequences; and determining bitrate allocation for the channels responsive to the information collect and the rho-domain analysis.

### CROSS-REFERENCE TO RELATED APPLICATIONS

This application claims the benefit of U.S. Provisional Application No. 61/284,149 filed Dec. 14, 2009 and is incorporated herein.

### FIELD OF THE INVENTION

The invention is related to statistical multiplexing.

### BACKGROUND OF THE INVENTION

In applications such as video on demand, video surveillance, and broadcast systems, multiple video encoder programs need to work in parallel and share resources in a limited or constant bandwidth. How the bitrates among the multiple encoders are allocated is paramount.

A most straightforward method is to divide the bandwidth equally among the multiple video encoding programs. The disadvantage of this method is that the resulting quality of the video programs is likely to be at uneven quality levels at any instant in time especially when multiple video sequences will undoubtedly each have differing multiple scenes.

This allocation is addressed by some statistical multiplexing (Statmux) approaches. With Statmux, the statistical information collected on the video sequences is utilized as a basis to allocate the bitrate budget. With this there are basically two categories of approaches: feedback approach and look-ahead approach.

With feedback approaches, statistical measurements of video complexity are collected by the encoders as a by-product of the compression process. The statistics from all encoders are then used for bit allocation for the subsequent video. A feedback approach normally brings no additional computational complexity and is built on the assumption that the video complexity is consistent over time.

With look-ahead approaches, on the other hand, the complexity statistics are computed by preprocessing all video sequences prior to encoding. The results of preprocessing are then used to predict the rate required for encoding the future video. A look-ahead approach is made up of three steps: preprocessing, complexity estimation and bit budget decision. A look-ahead method can predict more accurate bitrate requirements from future video with the cost of preprocessing and a delay.

However, in many cases a consistent picture quality across different channels is still not achieved. As such, a need exists to maintain a consistent picture quality across different channels and furthermore maximize the overall quality of all channels.

### SUMMARY OF THE INVENTION

A statistical multiplexing (Statmux) method is provided that collects statistical information from each encoder program or channel in a broadcast system and then uses the information to allocate bit budgets in the system. The method comprises accessing a plurality of video sequences which can be each assigned to a unique channel in the broadcast system; collecting information from a plurality of the unique channels assigned to encode the corresponding video sequences; applying rho-domain analysis to the video sequences; and determining bitrate allocation for the channels responsive to the collecting and applying steps. The information can be or include bandwidth information. The rho-domain analysis can include determining percentages of zero coefficients for quantization parameters for frames in the video sequences and involve determining complexity metrics. The method can include determining boundaries of groups of pictures in the video sequences and applying sliding windows to the video sequences, wherein consecutive sliding window overlap and wherein the above steps are performed within each sliding window. The method can further involve encoding in a look-ahead mode in the rho-domain analysis, wherein a rho-domain rate model R(QP)=θ·(1ρ(QP)) is generated where theta (θ) is the model parameter depending on picture coding type (I, P or B) and video content and ρ(QP) is the percentages of zero coefficients and wherein complexity information for each video sequence responsive to rho-domain rate model is determined such that bitrate allocation is responsive to complexity information. The method can include selecting a representative group of pictures and setting the size of the sliding windows to vary as a function of the size of the representative group of pictures. The method can further include determining boundaries of groups of pictures in the video sequences; applying sliding windows to the video sequences, wherein consecutive sliding window overlap; encoding in a look-ahead mode in the rho-domain analysis; and determining complexity metrics applying step for the groups of pictures within the sliding windows. The method can further incorporate encapsulating the complexity metrics within at least one message; and conveying the at least one message to a Statmux controller, wherein the Statmux controller is adapted to perform the rho-domain analysis and to determine bitrate allocation. Additionally, the method can involve determining a complexity metric for a given sliding window by adding the individual complexity metrics of the groups of pictures within the given sliding window, wherein the bitrate allocation in the given sliding window for each channel is based on a ratio of the individual complexity metrics to the complexity metric for the given sliding window.

### BRIEF DESCRIPTION OF THE DRAWINGS

The invention will now be described by way of example with reference to the accompanying figures of which:

FIG. 1 is block diagram of a system using a Statmux controller according to the invention;

FIG. 2 is block diagram of look-ahead analysis according to the invention;

FIG. 3 is block diagram of the operation of a Statmux controller according to the invention;

FIG. 4 shows two video sequences along concurrent time lines with the sliding window according to the invention;

FIG. 5 shows two video sequences along concurrent time lines with multiple sliding windows according to the invention;

FIG. 6 shows two video sequences along concurrent time lines with a Statmux delay according to the invention; and

FIG. 7 shows two video sequences along concurrent time lines with a changing sliding window size according to the invention.

### DETAILED DESCRIPTION OF THE EMBODIMENTS

The embodiments of the invention incorporate a statistical multiplexing (Statmux) procedure in which the statistical information is collected from each encoder program and then used to allocate bit budgets for the encoders accordingly. The Statmux procedure causes sharing in a fixed bandwidth domain among multiple encoder programs.

The invention further incorporates Rho-domain pre-analysis tool to obtain frame complexity metrics in the Statmux procedure, wherein a model parameter theta (θ) is adaptively updated by coding statistic feedback to reflect the video content.

Additionally, embodiments of the invention incorporate finding bit budgets on the GOP (group of pictures) basis in the Statmux or joint rate control procedure, wherein the GOP boundaries are not required to be aligned between encoders. Additionally, different frame resolutions and frame rates can be effectively counted while maintaining consistent quality.

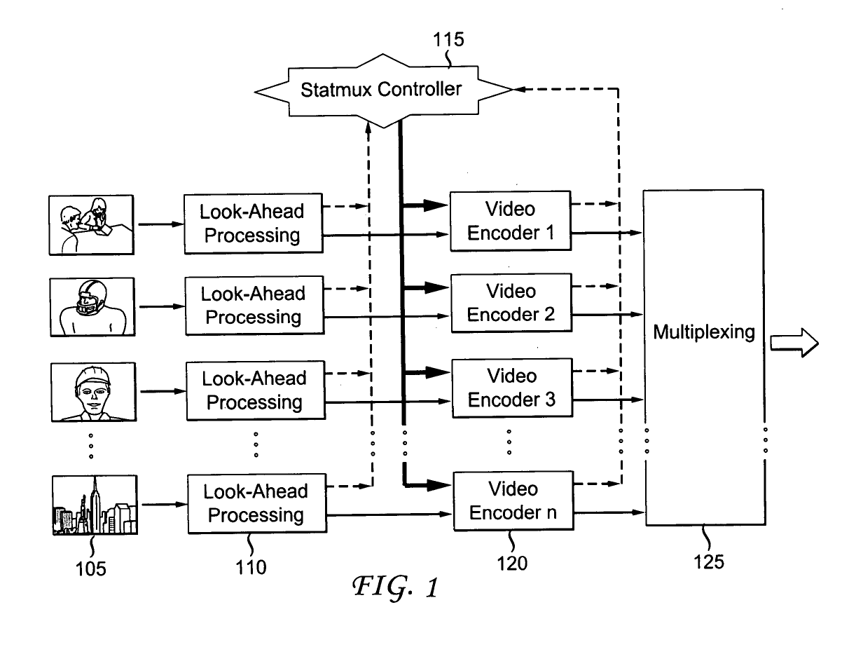

The application of a Statmux procedure can utilize the following components: 1) look-ahead analysis processing 110; 2) coding statistic feedback 115; and 3) applying a Statmux controller signals to encoders 120. This is generally represented in FIG. 1 whereby the plurality of video sequences 105 are multiplexed 125.

Embodiments of the invention adopt a rho-domain analysis in the look-ahead process 110 and determine a joint bit allocation in the Statmux controller application 120. With this Statmux application, a consistent quality can be maintained between encoders and maximized while the target bandwidth can be fully utilized. It should be noted that the GOP boundaries need not to be aligned.

A joint rate control or Statmux method according to the invention can operate based on rho(ρ)-domain rate modeling and a sliding window approach.

In the rho-domain modeling, rho is the percentage of zero coefficients after the transformation and quantization. Rho-domain analysis is built on the observation that less complex scene content normally will lead to more zero coefficients and need fewer bits to be represented. The following linear model is used in the rho-domain rate model:

R(QP)=θ·(1−ρ(QP)) (1)

where theta (θ) is the model parameter depending on picture coding type (I, P or B) and video content. The true value of theta can be calculated based on the actual bits used to encode a picture and then use to update the model parameter accordingly.

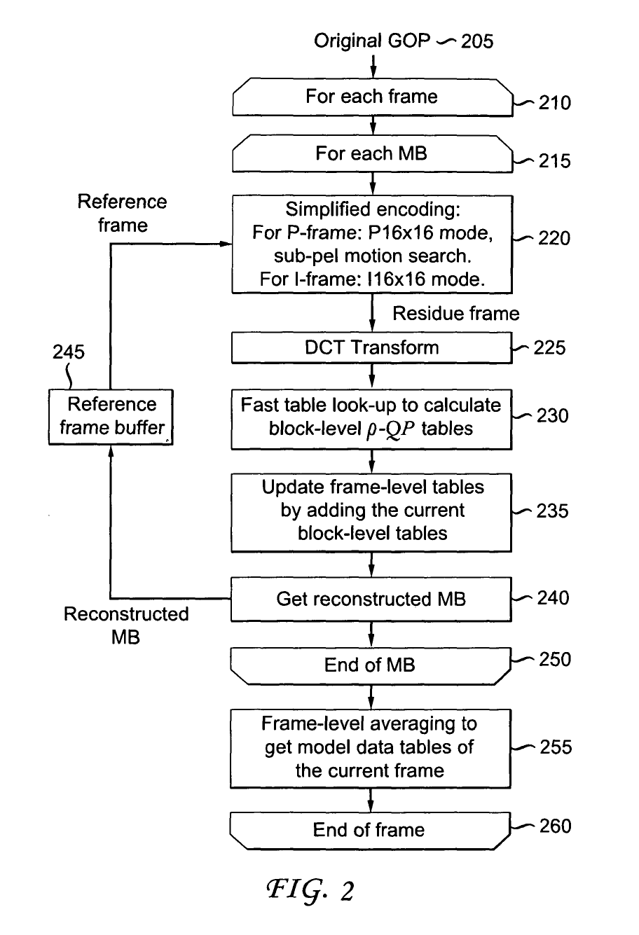

This rho-domain modeling is considered here to be part of a pre-analysis step used in the look-ahead analysis. This analysis is captured in the flowchart in FIG. 2. Here, for the given GOP 205 in each video sequence for each give encoder, each MB (macroblock) 215 in each frame 210 is analyzed. To limit the complexity, simplified encoding 220 in performed, wherein 16×16 motion compensation can be applied responsive to reference frames. The reference frames are reconstructed on an average QP deduced from previously encoded pictures 245. This encoding is followed by applying a discrete cosine transformation 225 on the encoded frames. A rho table 230 can then be used. This estimates the percentage of zero coefficients for each quantization parameter (QP) from 0 to 51 for each frame and is used to calculate block-level tables for each frame. From this, frame-level tables are updated 235 and the MBs in each frame are reconstructed 240 and then sent to the Statmux controller after frame-level averaging to get model data for the frames 255, thereby completing the look-ahead pre-analysis 260.

In one implementation, the pre-analysis can be performed as a separate process or thread in an encoder, which is not done within the Statmux controller.

An additional task of the pre-analysis is to determine the GOP structure when the maximum GOP size is reached or when a scene cut is detected, whichever happens first. The picture complexity information in one GOP will be encapsulated into a message and conveyed to the Statmux controller.

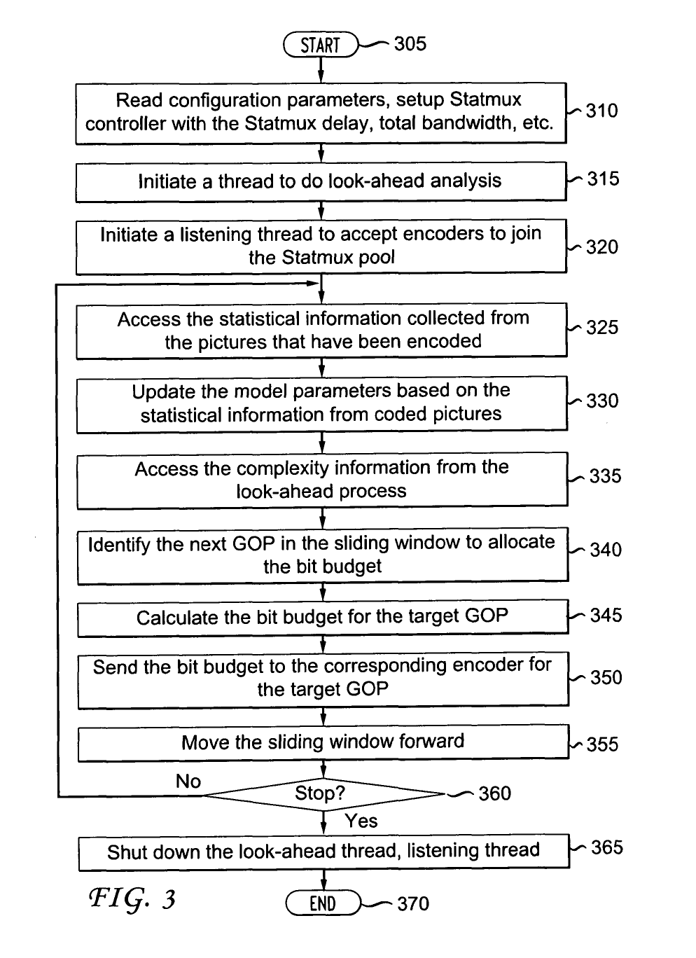

The Statmux controller is to assign bit budgets for a target GOP based on a joint bit allocation across a so-called sliding window with fixed size, which is generally a superset of the target GOP. The total complexity measure of the sliding window can be obtained by simply adding all the picture complexities together. After a total budget for the sliding window is found, a budget will be allocated for each picture as per its complexity proportion within the window. The sum of all picture budgets of the target GOP will be sent to its encoder and put into enforcement by the local rate control in the encoder. A flowchart on the Statmux controller is shown in FIG. 3. FIG. 3 provides the following steps:
Step 305 is the initiation of the controller;
Step 310 is setup step in which system reads configuration parameters, sets a Statmux delay, determines total bandwidth, and determines other important paraments;
Step 315 initiates a thread for look-ahead analysis;
Step 320 initiates a listening thread to accept encoders into the Statmux pool;
Step 325 accesses the statistical information collected from the pictures that have been encoded;
Step 330 updates the model parameters based on the statistical information from coded pictures;
Step 335 accesses the complexity information from the look-ahead process;
Step 340 identifies the next GOP in the sliding window to allocate the bit budget;
Step 345 calculates the bit budget for the target GOP;
Step 350 sends the bit budget to the corresponding encoders for the target GOP;
Step 355 advance the sliding window forward;
Step 360 is a decision step in which the process advances to Step 365 or loops back to Step 325;
Step 365 shuts down the look-ahead thread and listening thread; and
Step 370 signifies the end of Statmux phase of the process and permits the system to advance responsive to Statmux controller results.

A measure of complexity can be obtained based on rho-domain model. The complexity of frames is measured according to the number of bits estimated based on the rho values and can be represent as shown in equation 2.

$$\begin{matrix}Complexity ( QP ) {=}^{define } Bits ( QP ) = ( w \cdot h \cdot 3 / 2 ) \cdot R ( QP ) \\ = ( w \cdot h \cdot 3 / 2 ) \cdot θ \cdot ( 1 - ρ ( QP ) )\end{matrix} \qquad ( 2 )$$

Here, w and h are the width and height of the picture. It should be noted that each sequence will maintain two theta values for I pictures and P pictures, respectively. Theta is updated whenever a picture is finished in the following manner:

θ=0.8θ+0.2θ_{new} (3)

where θ_{new} is the true theta value from the newly encoded picture. A leaking parameter maintains a memory from history, which is set to 0.8 heuristically. It is noted that the coding statistic information needs be provided as a feedback from the coding process to the look-ahead process.

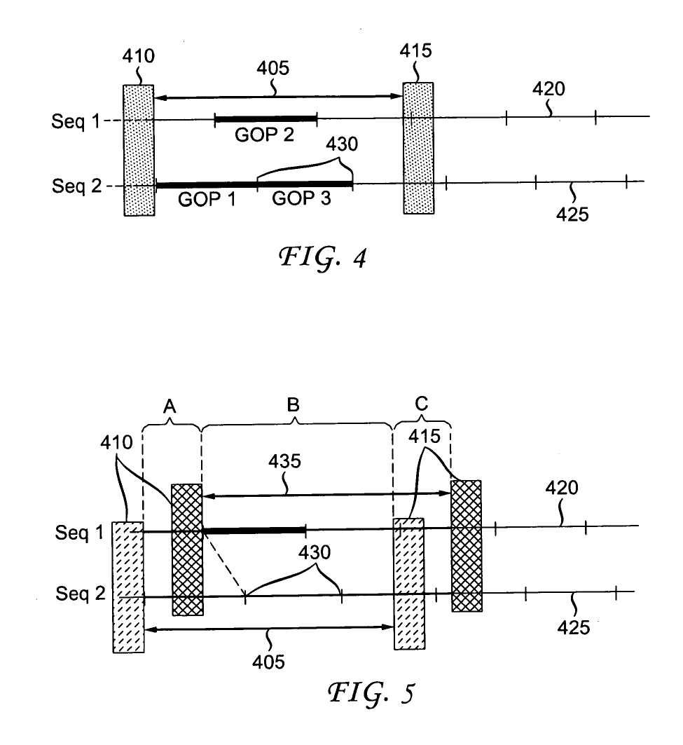

It is paramount to identify a target GOP to do bit allocation. The sliding window moves forward as time elapses. The GOP that reaches the window's left boundary first will be the next target GOP for bit allocation. In case more than one GOP is reached at the same time, they can be set as target GOPs in any order. In FIG. 4, bit budgets will be assigned in the order of GOP 1, GOP 2, and GOP 3. FIG. 4 shows two video sequences along concurrent time lines 420, 425, where the sliding window 405 is shown as having left boundary 410 and a right boundary 415. The beginning and/or ending of GOPs 430 are shown with tick marks along the time lines 420, 425.

Generally, when the sliding window moves to a new position as illustrated in FIG. 5, the pictures can be classified into three types. Pictures of type A have budgets assigned already. FIG. 5 shows the original sliding window 405 of FIG. 4, but now shows another sliding window 435 later in time having its own left boundary 410 and a right boundary 415. Pictures of type A shown in FIG. 5 have budgets already assigned and bounded between the two left boundaries 410 of the two windows 405, 435. Pictures of type B have budgets calculated as a result of joint bit allocation in the old sliding window 405, denoted by Budget_{B}, which were however not really assigned and is carried to the new sliding window 435. This allocation is defined by the left boundary 410 of new sliding window 435 and the right boundary 415 of the old sliding window 405. Pictures of type C, which are bounded by right boundary 415 of old sliding window 405 and the right boundary 415 of the new sliding window 435, are new pictures entering the sliding window, which will bring an additional budget, Budget_{C}, which is represented as follows:

Budget_{C}=LengthOfPartC*TotalBandwidth. (4)

The total budget for the new sliding window (part B and C) will be given as:

Budget_{Win}=Budget_{B}+Budget_{C}. (5)

Then Budget_{Win} can be spread through the pictures in part B and part C. It is assumed that constant QP will result in a consistent quality. Using the equation 1, one can find the minimum, QPₘᵢₙ, that achieves the closest bits to Budget_{Win} when it is applied to all the pictures in part B and part C.

Once QPₘᵢₙ is identified, the budget for pictures in part B and part C will be calculated according to its proportion in the total complexity:

$${Budget}_{i} = {Budget}_{win} \cdot \frac{Complexity ( {QP}_{min} , i )}{{\sum }_{i ∈ partB ‖ i ∈ part C}^{ } Complexity ( {QP}_{min} , i )} \qquad ( 6 )$$

Finally, the budget for the target GOP is counted by adding the picture budgets in the GOP and then are sent to the encoder. Note that the budget for the other pictures in the sliding window will be stored in Budget_{B} for reference in the next sliding window.

The carryover of Budget_{B} to the next sliding window makes the total budget for a Statmux session exactly equal to the product of total bandwidth and the session duration.

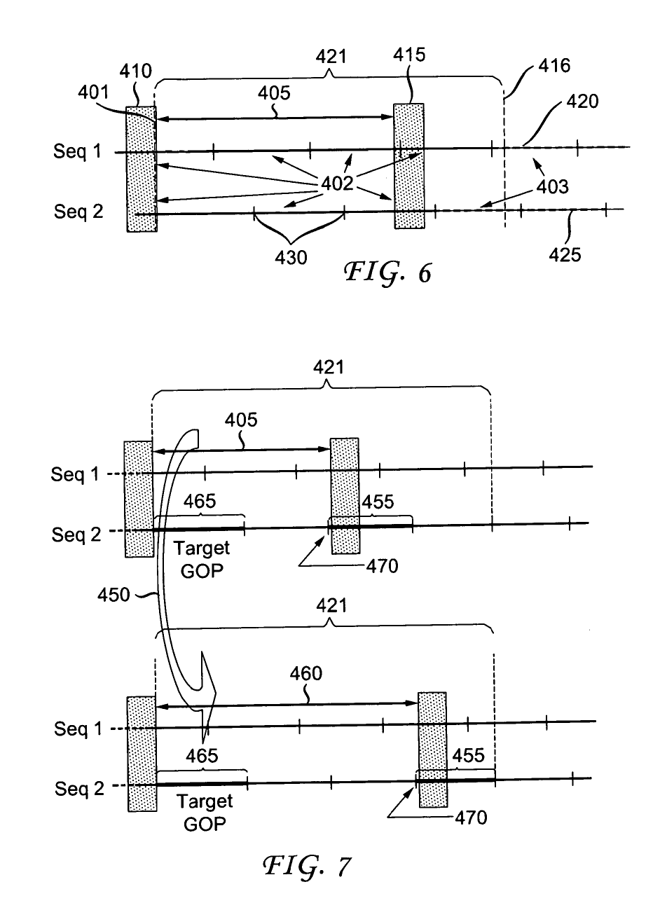

Next, the Statmux delay and size of the sliding window will be discussed. To ensure having the complexity information of all pictures within a sliding window available for the joint budget calculation and validating the above Statmux algorithm, a Statmux delay has to be introduced, which is an initial latency since the first picture is fed to the encoder until it is assigned a budget by the controller. Because the end of a GOP cannot be confirmed before the last picture in the GOP is analyzed, the complexity information is not available for those GOPs with ending timestamps falling beyond the Statmux delay given the start point of the sliding window. For example, in FIG. 6, GOP information is available for the GOPs in solid lines while not for those in dotted lines along the time lines 420, 425. The start point 401 of the sliding window 405 represents the initiation of the GOP information available and the arrows 402 show the GOP information available for the video sequences 1 and 2 for sliding window 405 on the solid line. The arrows 403 show the GOP information not available yet as represented by the dotted line. The Statmux delay 421 is shown as extending between start point 401 of the sliding window 405 to a point 426 beyond the right boundary 415.

The Statmux delay 421 can be set to a couple of seconds depending on the requirements of the target application. It shall be noted that Statmux delay is a feature of the Statmux pool and thus all the encoders within the same Statmux pool will be subject to the same Statmux delay. The Statmux delay is posted to the encoder in the acknowledgement message by the Statmux controller.

The size of the sliding window affects the number of pictures that are counted for the joint bit allocation. A larger window means more knowledge on the future scenes and the controller can thus maintain more consistent quality across the pictures, because more bits can be deferred to the future pictures if a target GOP is less active and save more bits for future pictures. However, the flexible way to use bits can lead to instant bit rate overshooting or undershooting, which is more serious; hence, the streaming buffer needs to be larger to smooth out the overshooting and undershooting and a larger delay is then required. A proper sliding window size shall be selected as a trade-off for a particular target application.

The minimum size of sliding window should be equal to the maximum GOP size, since the budget is sent to the encoders on the GOP basis. On the other hand, the size of sliding window should be less than the Statmux delay 421. More specifically, the maximum sliding window size 460 should be equal to the Statmux delay minus maximum GOP size plus one frame. FIG. 7 shows how the maximum sliding window size 460 should be set in the worst case with a “tailing” GOP 455 which has a maximum GOP size and its first frame is located at the end of the current sliding window. Large arrow 450 shows transition from a smaller window size in the upper scenario in FIG. 7 to a larger window in the lower scenario. A “tailing” GOP 455 refers to the last GOP within the sliding window. Arrows 470 are intended to represent that the tailing GOP has one frame within the respective sliding windows 405, 460. The window size can be increased until the end of the “tailing” GOP reaches the end of the Statmux delay. The target GOP 465 is also shown in FIG. 7.

According to the minimum and maximum sliding window size, it can be induced that the minimum Statmux delay should be equal to twice the maximum GOP size, minus one frame.

Regarding intra-program constraints, when the Statmux controller calculates the GOP bit budget for a video program encoder, it also has to account for some constraints of each individual program itself. This is mainly intra-program quality change constraints and decoder buffer constraints. Quality change constraint specifies the maximum GOP to GOP quality change, such that the visual experience of each individual coded video program will be more consistent, which is more desirable for human visual systems. The decoder buffer model is useful in a video transmission system. Each decoder buffer model is defined with buffer size, initial buffer level, and buffer output bit rate. For example, H.264 video standard defines HRD (hypothetical reference decoder) buffer model in its Annex C. To avoid buffer over-flow and under-flow, the number of coded bits of a frame has to conform to a certain upper- and/or lower-bound. Therefore, buffer constraints have also be considered in Statmux bit allocation for a GOP.

In one implementation, one could calculate the average QP of the last coded GOP, denoted by QP_{prevGOP}, for each video program or encoder, and when the Statmux controller calculates bit budget for the current GOP, the resultant QP of the GOP, denoted by QP_{currGOP}, should be properly constrained to prevent overly aggressive dynamic changes in quality. The constraint could be as follows:

QP_{currGOP}=min(QP_{prevGOP}+ΔQPₘₐₓ,QPₘₐₓ,max(QP_{prevGOP},ΔQPₘₐₓ,QPₘᵢₙ,QP_{currGOP})). (7)

ΔQPₘₐₓ denotes the maximum inter-GOP QP change, which can be fixed to a value such as 6˜8, or adapted based upon actual experimental results of dynamic quality change. QPₘₐₓ and QPₘᵢₙ are defined by a video coding standard, e.g. 51 and 0 in H.264.

As for intra-program decoder buffer constraints, in GOP bit allocation via Statmux, one can calculate the GOP bit budget such that after coding the GOP with the given bit budget the resultant buffer level will be close enough to a pre-specified ideal buffer level, such that there is still significant room, i.e. with loose upper and lower bounds for the next GOP bit budget. The constraint can be applied as follows:

B·(Full_{ideal}−ΔFull_{down})≦L_{currGOPstart}+Bits_{currGOP}−R·GOPSize/FR≦B·(Full_{ideal}+ΔFullᵤₚ) (8)

Here, B is buffer size in bits and Full_{ideal} is ideal buffer fullness, which can be, for example, 0.8. ΔFull_{down} and ΔFullᵤₚ define the desirable range of the buffer fullness, wherein suitable values can be as follows: ΔFull_{down}=0.4 and ΔFullᵤₚ=0.1. Lcurr_{GOP,start} denotes the buffer level before coding the current GOP. Bits_{currGop} denotes the bit budget of the current GOP. R is the output rate of the buffer, i.e. the target coding bit rate. GOP_{Size} is the total number of frames in the current GOP. FR is frame rate.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

The implementations and features of the invention can be used in the context of coding video and/or coding other types of data such as audio.

1. A method comprising the steps of:
accessing a plurality of video sequences, said video sequences each assigned to a unique channel in a common broadcast system;
collecting information from a plurality of the unique channels assigned to encode the corresponding video sequences;
applying rho-domain analysis to the video sequences; and
allocating bitrates among the channels responsive to the collecting and applying steps.

2. The method of claim 1, wherein the information is bandwidth information.

3. The method of claim 1 further comprising determining percentages of zero coefficients for quantization parameters for frames in the video sequences in the applying step.

4. The method of claim 1 further comprising determining complexity metrics in the applying step.

5. The method of claim 1 further comprising determining boundaries of groups of pictures in the video sequences.

6. The method of claim 5 further comprising applying sliding windows to the video sequences, wherein consecutive sliding window overlap.

7. The method of claim 6 wherein accessing, collecting, applying, and determining steps are performed within each of the sliding windows.

8. The method of claim 1 further comprising encoding in a look-ahead mode in the rho-domain analysis.

9. The method of claim 3 further comprising:
encoding in a look-ahead mode in the rho-domain analysis, wherein a rho-domain rate model R(QP)=θ·(1−ρ(QP)) is generated where theta (θ) is the model parameter depending on picture coding type (I, P or B) and video content and ρ(QP) is the percentages of zero coefficients; and
determining complexity information for each video sequence responsive to rho-domain rate model, wherein bitrate allocation is responsive to complexity information.

10. The method of claim 7 further comprising:
selecting a representative group of pictures; and
setting the size of the sliding windows to vary as a function of the size of the representative group of pictures.

11. The method of claim 1 further comprising
applying sliding windows to the video sequences, wherein consecutive sliding window overlap; and
determining complexity metrics in the applying step for groups of pictures within the sliding windows.

12. The method of claim 1 further comprising
determining boundaries of groups of pictures in the video sequences;
applying sliding windows to the video sequences, wherein consecutive sliding window overlap;
encoding in a look-ahead mode in the rho-domain analysis; and
determining complexity metrics in the applying step for the groups of pictures within the sliding windows.

13. The method of claim 6 further comprising
encapsulating the complexity metrics within at least one message; and
conveying the at least one message to a Statmux controller, said Statmux controller being adapted to perform the applying rho-domain analysis step and the determining bitrate allocation step.

14. The method of claim 6 further comprising
determining a complexity metric for a given sliding window by adding the individual complexity metrics of the groups of pictures within the given sliding window, wherein the bitrate allocation in the given sliding window for each channel is based on a ratio of the individual complexity metrics to the complexity metric for the given sliding window.
